(19) United States
(12) Patent Application Publication
(10) Pub. No.: US 2006/0288606 A1
(43) Pub. Date: Dec. 28, 2006

(54) Pocket ventilator

(76) Inventor: Dominique Thifault, Montreal (CA)

Correspondence Address: BURNS & LEVINSON LLP, 1700 K STREET, NW, SUITE 720, WASHINGTON, DC, 20006, US

(21) Appl. No.: 11/167,715

(22) Filed: Jun. 27, 2005

(51) Int. Cl. F26B 11/02

(52) U.S. Cl. 34/455

(57) ABSTRACT

A paper web drying apparatus is described as comprising a device for controlling an injection of air in a drying pocket of the drying apparatus. The web drying apparatus generally comprises at least three substantially axially parallel rotatable drying cylinders, first and third cylinders being vertically offset from a second cylinder and the web being consecutively trained thereover defining the pocket therebetween. The apparatus may define a traditional pocket, an offset pocket, or other such pocket configurations known in the art. The device comprises an elongated structure longitudinally mounted adjacent and substantially parallel to the first cylinder and between the first and the third cylinders. A first lateral edge of the structure may be positioned proximal to a peripheral surface of the first cylinder thereby defining a gap therewith such that the web trained thereon may travel toward the second cylinder unobstructed by the structure while the structure reduces an inflow of air dragged into the pocket by a motion of the web from the first to the second cylinder.

### FIELD OF THE INVENTION

The invention relates to the art of papermaking and, more particularly, to a ventilation system for use in a dryer section of a paper machine.

### BACKGROUND OF THE INVENTION

Papermaking is a sophisticated operation involving massive and very expensive machines. The papermaking process requires that water be removed from the initial pulp fiber solution as the paper is formed. The pulp fiber solution, once in the drying section of a papermaking machine, is referred to as the paper web. The paper web is supported as it travels across the machine following a path during which moisture is progressively removed therefrom. The support is provided by endless sheets of porous fabric, felts, wires or other water and gas permeable support means, all of which are generically referred to as the “felt” or “felts” in the description and appended claims.

The paper web travels from what is referred to as the wet end of the machine to the dry end thereof. In its path, the paper web runs over numerous heated drying cylinders where moisture is evacuated therefrom either by direct evaporation or transfer of moisture to the felts or to the surface of the drying cylinders. A network of ventilator devices are used throughout the drying section in order to inject heated dry air at numerous locations and promote the removal of moisture from the papermaking machine. At the end, the machine outputs the resulting paper, which is then generally reeled to be shipped elsewhere.

Papermaking machines can be built according to numerous possible configurations. One configuration in particular is the twin-wire draw, where the papermaking machine comprises two superposed rows of axially-parallel and horizontally disposed heated drying cylinders. The paper web runs in a serpentine or zigzag path where it defines loops by alternating between the two rows of drying cylinders as it advances along the drying section. The paper web is being supported in most of its path with the assistance of the felts. There is generally one felt for each row of drying cylinders. Each felt presses the paper web on a portion of the surface of the drying cylinders of the corresponding row. Each felt also runs over a felt roller between each pair of adjacent drying cylinders of a same corresponding row. The felt rollers are located deep in the space between the two adjacent drying cylinders. This configuration allows to maintain the paper web in supporting contact with the felt as long as possible. The felt rollers essentially redirect a felt to the next drying cylinder of the same row.

It should be noted at this point that the terms “roller” or “rollers” and “cylinder” or “cylinders” are synonyms since both are elongated members with a circular cross-section, the only distinction in the present context being that the drying cylinders are generally much larger in diameter than the felt rollers and are heated by appropriate means that are well known in the art. The segregated use of the terms in the text is only for the purpose of clarity. The “cylinder” or “cylinders” are sometimes referred to as “drum” or “drums” in other documents.

Traditional drying cylinders and felt roller arrangements feature the felt roller being positioned intermediate the axis of rotation of adjacent drying cylinders, thus halfway between two adjacent drying cylinders. This arrangement is such that the web runs exposed in its travel from a tangency with the cylinder of one row to a tangency with a cylinder of the other row. As the web serpentines from one row to the other, a series of pockets are defined and delimited vertically by the drying cylinders and horizontally by the exposed segments of the web traveling therebetween. A network of ventilators may be intercalated, as taught by Turcotte in U.S. Pat. No. 5,074,278, between each drying cylinder of each row to inject heated dry air in each pocket and to promote the removal of moisture therefrom. In particular, Turcotte teaches in U.S. Pat. No. 5,074,278 a ventilation system that provides a set of plenums between the dryer cylinders. Each plenum comprises a plurality of orifices producing medium velocity air jets injecting dry heated air in the pockets through the felt and an orifice producing a high velocity air jet creating a negative pressure zone extracting moisture laden air from the pocket. This ventilation system was in particular developed to redirect the evacuation of the moisture laden air, which was previously directed under pressure out the open ends of the pockets, to significantly reduce turbulence thereat and consequently reduce web flutter, a prominent source of web break and production losses.

Alternative drying cylinder and felt roller arrangements are also well known in the art and each provide their own advantages and disadvantages over the conventional arrangement. One such arrangement moves the axis of rotation of the felt rollers backwards, more particularly towards the wet end of the machine such that the felts and the paper web remain in contact longer, thus minimizing the length of unsupported paper web as it travels from one drying cylinder to another. This offset configuration of the felt rollers results in creating what is known as offset pockets. In U.S. Pat. No. 6,412,192 by Boucher et al., U.S. Pat. No. 6,513,263 by Turcotte and U.S. Published patent application Ser. No. 2002/0100186 by Turcotte et al., examples of paper drying machines exhibiting an offset configuration are presented. Corresponding ventilator systems are also taught to address the various additional drying intricacies provided by these systems.

As papermaking machines are upgraded and pushed to run at ever higher speeds to meet increasing productivity and efficiency demands, namely reaching or even exceeding web processing speeds of 3500 feet/minute, each of the machine's subcomponents must be modified appropriately to address any new difficulties generated by these increased speeds. Of particular interest here are problems generated during the web drying process resulting from the increased travel speed of the web therein. Namely, as the web travels between the drying cylinders at high speed, a current of hot and moist air is dragged along with the surface of the web and penetrates the pockets, thereby directly and uncontrollably affecting the quality and quantity or air being processed in the pocket. This in turn reduces the controllability and efficiency of the drying process.

### SUMMARY OF THE INVENTION

It is therefore an aim of the present invention to provide an apparatus for drying a paper web in a papermaking machine wherein an airflow within drying pockets thereof is controlled.

It is also an aim of the present invention to provide a device for controlling an airflow in drying pockets of a paper web drying apparatus.

More specifically, in accordance with the present invention, there is provided an apparatus for drying a paper web in a papermaking machine, the apparatus comprising at least three substantially axially parallel rotatable drying cylinders, a first cylinder and a third cylinder being vertically offset from a second cylinder, the web being consecutively trained over the first, second and third cylinders defining a pocket therebetween, the apparatus further comprising an elongated structure longitudinally disposed adjacent and substantially parallel to the first cylinder and between the first and third cylinders, a first lateral edge of the structure proximal to a peripheral surface of the first cylinder defining a gap therewith such that the web trained thereon may travel toward the second cylinder while the structure reduces a flow of air dragged into the pocket by a motion of the web from the first cylinder to the second cylinder.

Also in accordance with the present invention, there is provided a method for controlling the injection of humid air into a drying pocket in a paper web drying apparatus, the web drying apparatus comprising at least three substantially axially parallel rotatable drying cylinders, a first cylinder and a third cylinder being vertically offset from a second cylinder and the web being consecutively trained thereover defining the pocket therebetween, the method comprising the steps of:
A) providing an elongated structure mountable adjacent the first cylinder and between the first and second cylinders;
B) mounting the structure such that a longitudinal axis thereof is substantially parallel to that of the first cylinder and such that a first lateral edge of the structure is proximal to a peripheral surface of the first cylinder thereby defining a gap therewith through which the web trained on the first cylinder may travel toward the second cylinder; and
C) reducing an inflow of air dragged into the pocket by a motion of the web from the first cylinder to the second cylinder using the structure as an air block to the pocket.

Still in accordance with the present invention, there is provided a device for controlling an injection of air in a drying pocket of a paper web drying apparatus, the web drying apparatus comprising at least three substantially axially parallel rotatable drying cylinders, a first cylinder and a third cylinder being vertically offset from a second cylinder and the web being consecutively trained thereover defining the pocket therebetween, the device comprising an elongated structure longitudinally mounted adjacent and substantially parallel to the first cylinder and between the first and third cylinders, a first lateral edge of the structure proximal to a peripheral surface of the first cylinder defining a gap therewith such that the web trained thereon may travel toward the second cylinder while the structure reduces an inflow of air dragged into the pocket by a motion of the web from the first cylinder to the second cylinder.

Still further in accordance with the present invention, there is provided an apparatus for drying a paper web, the apparatus comprising an upper row of rotatable drying cylinders, a lower row of rotatable drying cylinders, the web being trained through the rows forming at least one pocket, a porous dryer felt urging the web against the drying cylinders of the upper row while the web is trained thereover, a felt roller mounted between two successive drying cylinders of the upper row, referred as first upper and second upper drying cylinders, the felt roller guiding the felt away from the first upper cylinder and toward the second upper cylinder, a pocket ventilation system comprising means for establishing a positive pressure zone of air between the first upper cylinder and the felt roller outside the pocket causing air to penetrate in the pocket through the felt and means for producing an air jet between a cleft defined between the felt roller and the felt and a cleft defined between the second upper cylinder and the felt outside the pocket and directed away therefrom causing a negative pressure zone and constituting means for extracting moisture laden air from the pocket through the felt and, an elongated structure longitudinally mounted to the ventilation system adjacent and substantially parallel to the first upper cylinder, a first lateral edge of the structure proximal to a peripheral surface of the first upper cylinder defining a gap therewith such that the web trained thereon may travel through the gap while the structure reduces an inflow of air dragged into the pocket by a motion of the web from the first upper cylinder to the second row.

Other aims, objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a schematic side elevational view of a web dryer and drying pockets thereof in accordance with an illustrative embodiment of the present invention;

FIG. 2 is a top plan view of the dryer of FIG. 1;

FIG. 3 is an enlarged side elevational view of a drying pocket in the dryer of FIG. 1, which illustrates an air flow (dashed arrows) generated by a ventilation system therein and a function of an air block mounted to the ventilation system intercepting an inflow of air (full-line arrows) into the drying pocket; and

FIGS. 4A and 4B are enlarged side elevational views of the air block of FIG. 3 in closed and open positions thereof, respectively.

### DESCRIPTION OF ILLUSTRATIVE EMBODIMENTS

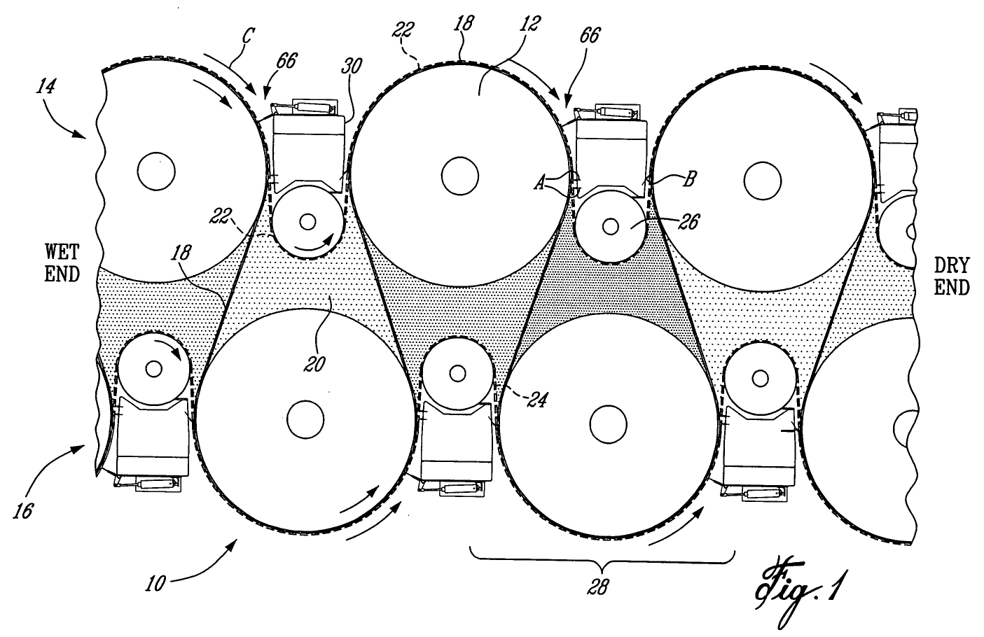

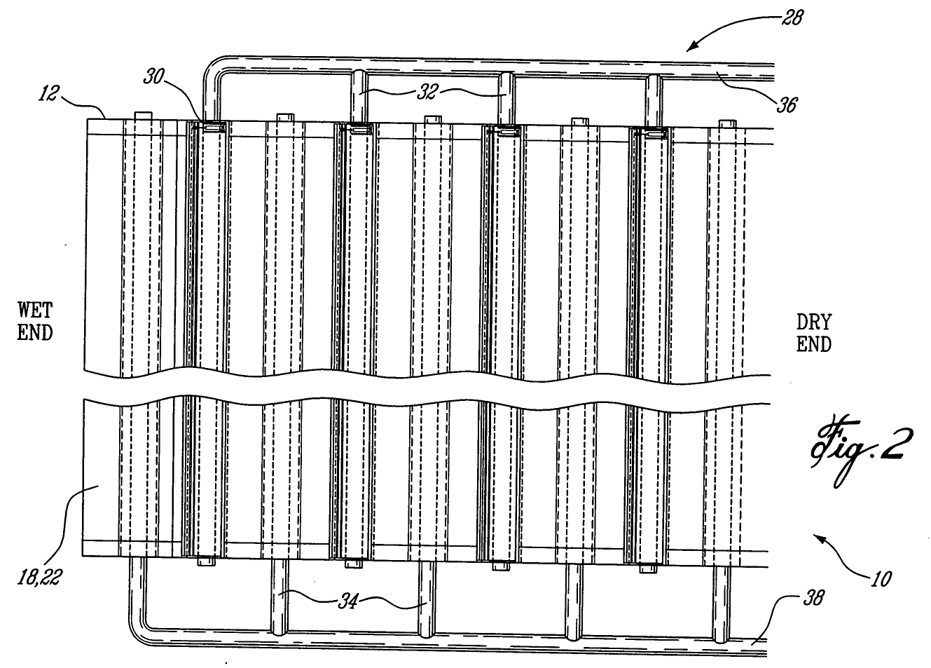

Referring to FIGS. 1 and 2, and in accordance with an illustrative embodiment of the present invention, a web dryer, generally referred to using the numeral 10, will now be described. The web dryer 10 comprises a plurality of heated drying cylinders 12 arranged in two vertically spaced apart rows, namely an upper row 14 and a lower row 16. A web 18 to be dried is trained over the cylinders 12 in a serpentine path defining a series of pockets 20, the pockets 20 being marked in FIG. 1 by stippled areas.

Two dryer felts 22 and 24, illustrated in dotted lines for illustrative purposes so as to be distinguishable from the full lines used to illustrate the paper web 18 and associated with the cylinder rows 14 and 16 respectively, are provided to press the web 18 against the cylinders 12 for a better heat transfer therebetween and consequently to increase the efficiency of the dryer 10. The upper dryer felt 18 is in wrapping engagement with each cylinder 12 of the upper row 14, and it is guided between adjacent cylinders by guide rollers 26. The structure of the lower felt 24 is the same as with the upper felt 22.

The direction of rotation of the various components of the dryer 10 is illustrated by means of arrows in the left hand side of FIG. 1.

It will be appreciated that during the operation of the dryer 10, that is during the travel of a section of the web 18 from one cylinder 12 in the upper row 14 to the next cylinder 12 in the lower row 16 and vice versa, moisture is released in the pockets 20. This moisture must be evacuated in order to enable the dryer 10 to function properly.

With reference mainly to FIG. 2, a ventilation system, designated by the reference numeral 28, comprises an air plenum 30 associated with each pocket 20. This arrangement creates an upper row 32 of plenums and a bottom row 34 of plenums, the plenums of the same row generally being connected to a common air supply duct 36 and 38 respectively connected to a suitable blower (not shown); in FIG. 1, the air supply ducts 36 and 38 are omitted to clarify the illustration. The air plenums 30 are held in their respective positions by means of an adequate supporting structure (not shown) that may be constructed of supporting beams or any other such members providing the required rigidity and strength characteristics needed to support the plenums 30.

To simplify the following description, the text will now focus on describing the components of the upper row of cylinders 14 and plenums 32 and their functions. A person of skill in the art will understand that the description provided hereinbelow may also apply to the components of the lower row of cylinders 16 and plenums 34 by considering the inverted orientation thereof with regards to the upper rows of cylinders 14 and of plenums 32. Namely, components and features oriented toward the wet end of the web dryer 10 in the upper rows will also be oriented toward the wet end of the web dryer 10 in the lower rows. Clearly, up and down directions will be reversed.

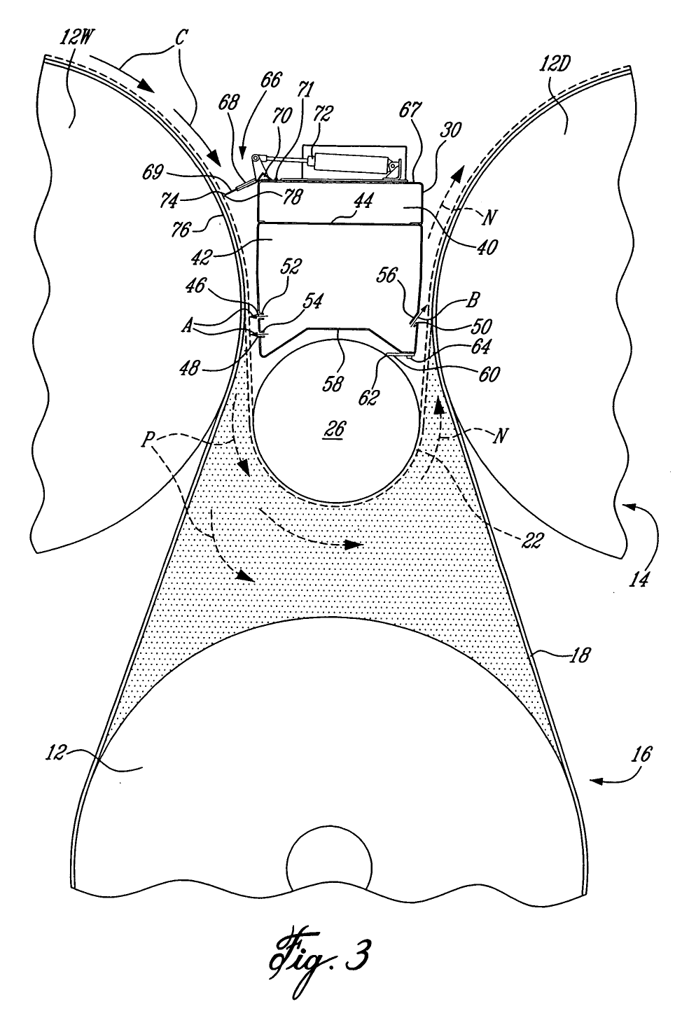

Referring now to FIG. 3, the structure of a plenum 30 will now be described. The air plenum 30 is an elongated and hollow structure, generally manufactured of sheet metal or the like, located in the space between two adjacent dryer cylinders 12, hereinafter cylinders 12W and 12D for the cylinders closest to the wet end and the dry end of the web dryer 10, respectively, and a guide roller 26. The plenum 30 generally extends the entire length of the cylinders 12 and the roller 26, in other words having a length corresponding to the width of the web dryer 10. The plenum 30 comprises an upper inlet chamber 40 which communicates with the air duct 36 (FIG. 2) by means of a suitable coupling (not shown) such as commonly known in the art. An outlet chamber 42 separated from the inlet chamber 40 by means of a perforated plate 44 is provided with orifices 46, 48 and 50 to eject from the outlet chamber 42 the air pumped therein through the plenum 30.

The orifices 46 and 48, which face the section of the dryer felt 22 that runs from the dryer cylinder 12W toward the roller 26, are parallel and are located at the level where the dryer felt 22 separates from the cylinder 12W. Each of the orifices 46 and 48 is defined between two lips 52 and 54 extending the entire length of the plenum 30 and retained thereto by retaining means including rivets, bolts and the like. The spacing between the lips 52 and 54 may be controlled by washers or the like having a predetermined thickness and being mounted to the retaining means. The inner extremities of the lips 52 and 54 may be flared to smoothly accelerate the airflow as it passes through the orifices 46 and 48.

The orifice 50 is positioned in an area facing the section of the dryer felt 22 which runs from the roller 26 to the dryer cylinder 12D. The orifice 50 is generally defined between angled lips 56 that run the entire length of the plenum 30 and that are again retained thereto by retaining means such as rivets, bolts and the like. The lips 56 generally extend upwardly and outwardly from the outlet chamber 42, in this illustrative embodiment above the contact point between the felt 22 and the web 18, and a spacing thereof may again be controlled by washers or the like having a predetermined thickness and being mounted to the retaining means. The inner extremities of the lips 56 may also be flared to smoothly accelerate the airflow as it passes through the orifice 50.

A bottom face 58 of the plenum 30 is generally constructed to contour the felt roller 26 located therebelow and provide a limited spacing between the roller 26 and the plenum 30. A seal 60 is also provided between the plenum 30 and the guide roller 26. More particularly, the seal 60 may be comprised of a strip 62 of fabric, of rubber or of other such materials, which is received into a bracket 64 that is welded or otherwise attached to the bottom face 58 of the air plenum 30.

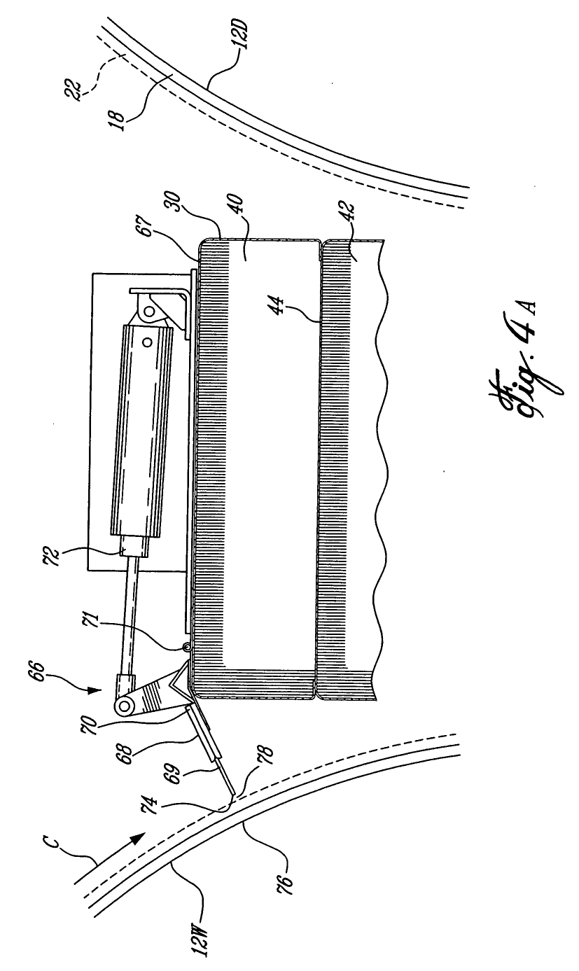

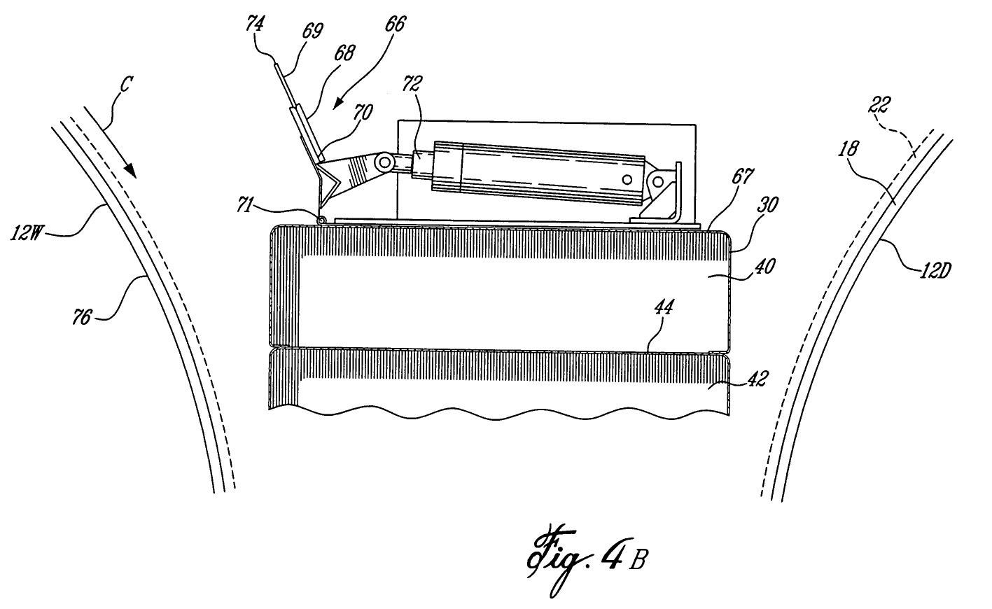

Still referring to FIG. 3, an air block 66 is mounted to a top face 67 of the plenum 30. The air block 66 is generally defined by a substantially flat and elongated member or structure 68 extending longitudinally along about a full length of the air plenum 30 and defining a longitudinal axis substantially parallel to the rotation axis of the dryer cylinders 12. The structure 68 is generally comprised of a blade or flap 69 that, when positioned in an operative closed position (FIG. 4A), extends laterally from the plenum 30 toward the wet end of the web dryer 10, and more particularly toward the dryer cylinder 12W and that, when positioned in an open position (FIG. 4B), extends upwardly from the plenum 30 and away from the dryer cylinder 12W. The blade or flap 69, which may be manufactured of fiberglass, plastic stainless steel, or other such materials appropriate to be used in the warm and humid environment of the web dryer 10, is mounted to a pivoting support arm 70 that is hingedly mounted about hinge 71 to the top face 67 of the plenum 30 and pneumatically actuated by a conventional pneumatic cylinder 72, or the like, connected thereto. Hydraulic, electric and mechanical actuation means may also be considered, as should now be apparent to a person of skill in the art, without departing from the general scope and nature of the present disclosure.

Referring now to FIGS. 3, 4A and 4B, the air block 66, as described hereinabove, may be adjusted or displaced between a closed position (FIG. 4A) and an open position (FIG. 4B). In the closed position, the blade or flap 69 extends laterally away from the top face 67 of the plenum 30 and toward the dryer cylinder 12W. Generally, an outer or free edge 74 of the blade or flap 69 is positioned proximally and substantially perpendicularly to a peripheral surface 76 of the dryer cylinder 12, and above the point where the felt 22 and the web 18 are separated and guided to the roller 26 and the lower row of cylinders 16, respectively. In this position, the outer edge 74 of the blade or flap 69 defines a small gap 78 with the peripheral surface 76 such that the web 18 and the felt 22 trained on the cylinder 12W may travel through the gap 78 unobstructed by the blade 69. In the open position, the blade 69 is brought up from the closed position and away from the drying cylinder 12W thereby increasing the width of the gap 78. Alternatively, the width of the gap 78 may also be adjusted by varying the length of the blade 69, that is by variably adjusting the positioning of the blade 69 relative to the support arm 70. A person of skill in the art will understand that various blade fastening and adjusting means may be considered to variably position the blade 69 relative to the support arm 70 and adjust the width of the gap 78. Further, the air block 68 may be constructed to allow an easy access and replacement of the blades 69 when needed either to adjust the width of the gap or to replace a damaged blade 69 or other such air block components.

Referring now to FIGS. 2 and 3, the operation of the ventilation system 28, and associated components thereof, will be presented. The air pumped through inlet duct 36 enters the inlet chamber 40 of each respective plenum 30 where it is channeled in the outlet chamber 42 through the perforated plate 44. The latter is used in order to diffuse and smooth out the airflow. The air mass leaving through the orifices 46 and 48 will create medium velocity jets, designated by arrows A (FIG. 3), establishing a positive pressure zone immediately downstream of the point where the dryer felt 22 separates from the cylinder 12W. This positive pressure zone will pump air in the pocket 20 (dashed arrows P) thereby increasing the pressure therein. A plurality of medium velocity jets are preferred over an arrangement using a single high velocity jet because it has been found that in the latter case, a substantial quantity of the air simply bounces off the dryer felt 22 and does not penetrate the pocket 20. When a less turbulent pressure zone is created by means of medium velocity jets, as in A, the air quantity pumped in the pocket 20 is substantially augmented.

The orifice 50, producing an air jet, designated by arrow B, that is generally vertically directed away from the pocket 20, will create a negative pressure zone on the side of the dryer felt 22 that extends from the guide roller 26 to the dryer cylinder 12D. The negative pressure zone will have the effect of extracting through the dryer felt 22 moisture laden air from the pocket 20 (dashed arrows N) in order to minimize the quantity of moisture laden air exiting the pocket 20 through the open ends thereof, thus reducing the possibility of turbulence and web flutter.

The seal 60 is used to prevent direct passage of air below the plenum 30 from the positive pressure zone to the negative pressure zone, thereby further forcing the heated dry air into the pocket 20 and around the roller 26 to finally reach the low pressure zone on the opposite side of the plenum 30 and exit the pocket 20.

Referring now to FIGS. 3, 4A and 4B, the air block 66, mounted atop the plenum 30, is selectively positioned to control an inflow of air dragged along the surface of the web 18 and felt 22 by the motion thereof around the drying cylinder 12W; this flow is schematically illustrated by arrows C. In fact, this inflow of air is generally undesirable as it brings into the pocket 20 a quantity of humid air that not only increases the air pressure within the pocket 20, a parameter generally carefully controlled and monitored by the ventilation system 28 to reduce the occurrence of web flutter at the ends of the pocket 20, but also reduces the drying efficiency of the web dryer 10 by exposing the web 18 within the pocket 20 to excess humidity. As the web dryer 10 operates at increasing speeds, namely reaching or even exceeding web processing speeds of 3500 feet/minute, this effect becomes increasingly troublesome as greater air currents, as in C, are generated by the motion of the web 18 and felt 22 on the cylinder 12W and injected inside the pocket 20.

To overcome the negative effects induced by the humid air currents C, the air block 66 can be selectively positioned to control the inflow of humid air in the pocket 20. For instance, when positioned in the closed position (FIG. 4A), the undesired air currents are practically fully intercepted by the air block 66. Namely, by adjusting the gap 78 to a width corresponding to about the thickness of the web 18 and the felt 22 combined, most of the humid air dragged down along the surface of the web 18 and felt 22 will be intercepted, greatly reducing the amount of humid air infiltrating the pocket 20. If, on the other hand, it is desired to allow a controllable amount of humid air to infiltrate the pocket 20 through the gap 78, the air block 66 may be actuated and positioned away from its closed position, or even at its completely open position (FIG. 4B), thereby increasing the width of the gap 78 and permitting a greater inflow of humid air into the pocket 20.

Using this novel air block 68, the quantity and quality of air being injected into the drying pockets 20 may be better controlled. Namely, adverse effects, such as pocket turbulence and web flutter, generated in drying machines as the web dryer 10, which operate at ever increasing speeds, may be reduced and even eliminated. Further, the drying efficiency and controllability of the web dryer may be optimised.

As will now be apparent to a person of skill in the art, other machine and ventilation system configurations may benefit from the addition of an air block 66, as defined hereinabove, to reduce an inflow of humid air into the machine's drying pockets. Namely, machines using offset pocket configurations and ventilation systems configured therefor may also benefit from such addition. Use of the above-described air block 66 in combination with these alternative drying machine configurations may be considered without departing from the general scope and nature of the present disclosure.

Although an illustrative embodiment of the invention has been described above, it should be understood that this description should not be interpreted in any limiting manner since many variations and refinements are possible without departing from the spirit of the invention. The scope of the invention will be defined in the annexed claims.

1-32. (canceled)

33. A method of manufacturing semiconductor devices in a multi-chamber wafer processing system, comprising:
mounting on a cassette stage a cassette that has wafers stacked thereon;
providing a plurality of processing chambers adapted to process the wafers under vacuum pressure;
providing a first load lock chamber adapted to pass wafers to and from the plurality of processing chambers;
maintaining a horizontal transfer path at atmospheric pressure, the horizontal transfer path providing space for transportation of wafers between the cassette stage and the load lock chamber; and
loading and unloading the wafers stacked on the cassette stage to and from the load lock chamber using a transfer mechanism installed in the horizontal transfer path.

34. The method of claim 33, wherein the wafers are vacuum absorbed to the transfer mechanism while being loaded and unloaded from the cassette stage to and from the first load lock chamber.

35. The method of claim 33, wherein the transfer mechanism includes a plurality of transfer arms, said loading and unloading of the wafers comprising transferring a plurality of wafers using the plurality of transfer arms.

36. The method of claim 33, where the plurality of process chambers and the first load lock chamber are aligned along a first direction in parallel with the horizontal transfer path.

37. The method of claim 33, further comprising:
providing a second plurality of processing chambers adapted to process the wafers under vacuum pressure; and
providing a second load lock chamber adapted to pass the wafers to and from the second plurality of processing chambers.

38. The method of claim 37, further comprising transferring the wafers from the first load lock chamber to the second load lock chamber using a second transfer mechanism in the horizontal transfer path.

39. The method of claim 37, where the first and second plurality of process chambers and the first and second load lock chambers are all aligned along a first direction in parallel with the horizontal transfer path.

40. The method of claim 33, further comprising, after a process is performed in one processing chamber, moving wafers to another processing chamber for a subsequent process without passing through the horizontal transfer path.

41. A method of manufacturing semiconductor devices in a multi-chamber wafer processing system, comprising:
providing a wafer on a wafer stage;
transferring the wafer under atmospheric pressure along a horizontal transfer path from the wafer stage to a first load lock chamber;
providing a vacuum pressure in the first load lock chamber;
transferring the wafer from the first load lock chamber to a first process chamber;
performing a first process on the wafer under a vacuum pressure in the first process chamber;
transferring the wafer from the first process chamber to a second process chamber;
performing a second process on the wafer under a vacuum pressure in the second process chamber;
transferring the wafer from the second process chamber to the first load lock chamber;
providing an atmospheric pressure in the first load lock chamber; and
transferring the wafer under atmospheric pressure along the horizontal transfer path from the first load lock chamber to the wafer stage.

42. The method of claim 41, where the first and second process chambers and the first load lock chamber are all aligned along a first direction in parallel with the horizontal transfer path.

43. The method of claim 41, wherein transferring the wafer under atmospheric pressure along a horizontal transfer path from the wafer stage to the first load lock chamber includes vacuum absorbing the wafer to a transfer mechanism in the horizontal transfer path.

44. The method of claim 43, further comprising transferring a second wafer from a second load lock chamber to a third load lock chamber under atmospheric pressure along the horizontal transfer path by vacuum absorbing the second wafer to a second transfer mechanism in the horizontal transfer path.

45. The method of claim 44, where the plurality of process chambers and the first, second, and third load lock chambers are all aligned along a first direction in parallel with the horizontal transfer path.

46. The method of claim 41, wherein transferring the wafer under atmospheric pressure along the horizontal transfer path from the first load lock chamber to the wafer stage comprises:
transferring the wafer from the first load lock chamber to a second load lock chamber under atmospheric pressure along the horizontal transfer path; and
transferring the wafer under atmospheric pressure along the horizontal transfer path from the second load lock chamber to the wafer stage.

47. The method of claim 46, where the plurality of process chambers and the first and second load lock chambers are all aligned along a first direction in parallel with the horizontal transfer path.

48. The method of claim 41, further comprising:
providing a second wafer on the wafer stage; and
transferring the second wafer under atmospheric pressure along the horizontal transfer path from the wafer stage to the first load lock chamber at a same time as transferring the first wafer under atmospheric pressure along the horizontal transfer path from the wafer stage to the first load lock chamber, where the first and second wafers are transferred on two different transfer arms.

49. The method of claim 41, wherein transferring the wafer under atmospheric pressure along the horizontal transfer path from the wafer stage to the first load lock chamber comprises moving the transfer arm horizontally using a motor or a pneumatic cylinder.

50. The method of claim 41, wherein the first load lock chamber is located at a first side of the transfer path, and the cassette stage is located at a second side of the transfer path, the first side of the horizontal transfer path being opposite to the second side of the horizontal transfer path.

51. The method of claim 41, further comprising:
providing a second wafer on the wafer stage; and
transferring the second wafer under atmospheric pressure along the horizontal transfer path from a second wafer stage to a second load lock chamber at a same time as transferring the first wafer under atmospheric pressure along the horizontal transfer path from the wafer stage to the first load lock chamber.

52. The method of claim 41, further comprising transferring the wafer from a first transfer mechanism in the horizontal transfer path to a second transfer mechanism in the horizontal transfer path.

53. A method of manufacturing semiconductor devices in a multi-chamber wafer processing system, comprising:
providing a wafer on a wafer stage;
transferring the wafer under atmospheric pressure along a horizontal transfer path from the wafer stage to a first load lock chamber;
providing a vacuum pressure in the first load lock chamber;
transferring the wafer from the first load lock chamber to a first process chamber;
performing a first process on the wafer under a vacuum pressure in the first process chamber;
transferring the wafer from the first process chamber to the first load lock chamber;
providing an atmospheric pressure in the first load lock chamber; and
transferring the wafer under atmospheric pressure along the horizontal transfer path from the first load lock chamber to the wafer stage.

54. The method of claim 53, wherein transferring the wafer under atmospheric pressure along a horizontal transfer path from the wafer stage to the first load lock chamber includes vacuum absorbing the wafer to a transfer mechanism in the horizontal transfer path.

55. The method of claim 54, further comprising transferring a second wafer from a second load lock chamber to a third load lock chamber under atmospheric pressure along the horizontal transfer path by vacuum absorbing the second wafer to a second transfer mechanism in the horizontal transfer path.

56. The method of claim 53, wherein transferring the wafer under atmospheric pressure along the horizontal transfer path from the first load lock chamber to the wafer stage comprises:
transferring the wafer from the first load lock chamber to a second load lock chamber under atmospheric pressure along the horizontal transfer path; and
transferring the wafer under atmospheric pressure along the horizontal transfer path from the second load lock chamber to the wafer stage.

57. The method of claim 53, wherein transferring the wafer under atmospheric pressure along the horizontal transfer path from the wafer stage to the first load lock chamber comprises moving the transfer arm horizontally using a motor or a pneumatic cylinder.

58. The method of claim 53, wherein the first load lock chamber is located at a first side of the transfer path, and the cassette stage is located at a second side of the transfer path, the first side of the horizontal transfer path being opposite to the second side of the horizontal transfer path.

59. The method of claim 53, further comprising:
providing a second wafer on the wafer stage; and
transferring the second wafer under atmospheric pressure along the horizontal transfer path from a second wafer stage to a second load lock chamber at a same time as transferring the first wafer under atmospheric pressure along the horizontal transfer path from the wafer stage to the first load lock chamber.

60. The method of claim 53, further comprising transferring the wafer from a first transfer mechanism in the horizontal transfer path to a second transfer mechanism in the horizontal transfer path.
